(19) United States
(12) Patent Application Publication
(10) Pub. No.: US 2020/0293269 A1
(43) Pub. Date: Sep. 17, 2020

(54) ELECTRONIC DEVICE FOR PROCESSING AUDIO DATA AND OPERATING METHOD THEREOF

(71) Applicant: Samsung Electronics Co., Ltd., Suwon-si (KR)

(72) Inventors: Kyumin KIM, Suwon-si (KR); Youngki PARK, Suwon-si (KR); Injune CHOI, Suwon-si (KR); Misun KIM, Suwon-si (KR); Mira SEO, Suwon-si (KR)

(21) Appl. No.: 16/815,632

(22) Filed: Mar. 11, 2020

(30) Foreign Application Priority Data
Mar. 11, 2019 (KR) 10-2019-0027747

(51) Int. Cl. G06F 3/16; H04B 1/034

(52) U.S. Cl. CPC G06F 3/165; H04B 1/034

(57) ABSTRACT

An electronic device for processing audio data related to an FM radio and an operating method thereof is provided. An electronic device includes an FM radio module configured to receive FM audio data, an audio output module configured to output audio data, and a processor configured to be operatively connected to the FM radio module, the audio output module, and an audio buffer configured to at least temporarily store the received FM audio data, and configured to include a volume processor configured to adjust a volume level of the received FM audio data, wherein the processor may be configured to: receive FM audio data corresponding to a fixed volume level from the FM radio module to store the FM audio data in the audio buffer, convert the FM audio data corresponding to the fixed volume level, transmitted from the audio buffer, into FM audio data corresponding to a user volume level, and transmit the FM audio data corresponding to the user volume level to the audio output module. In addition, various embodiments are possible.

### CROSS-REFERENCE TO RELATED APPLICATION(S)

This application is based on and claims priority under 35 U.S.C. § 119(a) of a Korean patent application number 10-2019-0027747, filed on Mar. 11, 2019, in the Korean Intellectual Property Office, the disclosure of which is incorporated by reference herein in its entirety.

### BACKGROUND

### 1. Field

The disclosure relates to an electronic device. More particularly, the disclosure relates to processing audio data related to an FM radio and an operating method thereof.

### 2. Description of Related Art

Portable electronic devices, such as a smartphone, can provide not only basic services, such as phone-calling and texting, but also various complex services, such as a service for providing various types of contents including multimedia, games, and financial transaction services. Multimedia content includes broadcast multimedia content transmitted from broadcast media, such as TV and radio, and a portable electronic device includes a separate hardware module (e.g., an FM radio chipset) to provide broadcast multimedia content to a user. A portable electronic device including an FM radio chipset may provide not only a service for providing FM radio content but also a service for recording FM radio content. Accordingly, a user may store audio data corresponding to FM radio content in the portable electronic device using the service for recording the FM radio content.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, as the performance of portable electronic devices is enhanced and the number of tasks (e.g., running applications) that the portable electronic devices can simultaneously process increases, the portable electronic devices can provide one or more other services to users while providing a service for recording FM radio content. For example, a user can play digital media stored in a portable electronic device or may play an image through the Internet while recording FM radio content. Here, when the user controls the volume, the controlled volume may be reflected in audio data generated through the service for recording FM radio content.

Additional aspects will be set forth in part in the description which follows and, in part, will be apparent from the description, or may be learned by practice of the presented embodiments.

Accordingly, some portable electronic devices are set to prohibit volume control while recording FM radio content, thus causing inconvenience of not allowing volume control to users and imposing a restriction such that users need to suspend recording the FM radio content to control the volume.

In accordance with an aspect of the disclosure, an electronic device is provided. The electronic device includes an FM radio module configured to receive FM audio data, an audio output module configured to output audio data, and a processor configured to be operatively connected to the FM radio module, the audio output module, and an audio buffer configured to at least temporarily store the received FM audio data, and configured to include a volume processor configured to adjust a volume level of the received FM audio data, wherein the processor may be configured to: receive FM audio data corresponding to a fixed volume level from the FM radio module to store the FM audio data in the audio buffer, convert the FM audio data corresponding to the fixed volume level, transmitted from the audio buffer, into FM audio data corresponding to a user volume level, and transmit the FM audio data corresponding to the user volume level to the audio output module.

In accordance with an aspect of the disclosure, an electronic device is provided. The electronic device includes an FM radio module configured to receive FM audio data, an audio output module configured to output audio data, and a processor configured to be operatively connected to the FM radio module and the audio output module, wherein the processor may be configured to include a first processor and a second processor, the first processor may be configured to run an FM radio application and to transmit information about a fixed volume level to the FM radio module, and the second processor may be configured to receive FM audio data corresponding to the fixed volume level from the FM radio module, to convert the FM audio data corresponding to the fixed volume level into FM audio data corresponding to a user volume level, and to transmit the FM audio data corresponding to the user volume level to the audio output module.

In accordance with an aspect of the disclosure, an operating method of an electronic device is provided. The electronic device includes an FM radio module configured to receive FM audio data and an audio output module configured to output audio data according to various embodiments may include: running an FM radio application, receiving FM audio data corresponding to a fixed volume level through the FM radio module, converting the FM audio data corresponding to the fixed volume level into FM audio data corresponding to a user volume level, and outputting the FM audio data corresponding to the user volume level through the audio output module.

An electronic device and an operating method thereof according to various embodiments enable a user to control the actually listening volume while recording FM radio content at a constant sound level (or volume), thus improving user convenience.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an electronic device according to an embodiment of the disclosure;

FIG. 3 illustrates a first processor according to an embodiment of the disclosure;

FIG. 4 illustrates a second processor according to embodiment of the disclosure;

FIG. 5 illustrates data flow for processing user volume control when an FM radio application is operated according to an embodiment of the disclosure;

FIG. 6 illustrates data flow for processing user volume control when an FM radio application is operated according to an embodiment of the disclosure;

FIG. 7 illustrates data flow for processing user volume control when an FM radio application is operated according to an embodiment of the disclosure;

FIG. 8 is a flowchart illustrating an operation sequence of an electronic device according to an embodiment of the disclosure;

FIG. 9 is a flowchart illustrating an operation sequence of an electronic device to whether an FM radio recording request is received according to an embodiment of the disclosure;

FIG. 10 is a flowchart illustrating an operation sequence of an electronic device according to an embodiment of the disclosure; and

FIG. 11 is a flowchart illustrating an operation sequence of an electronic device for generating an FM radio recording file according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

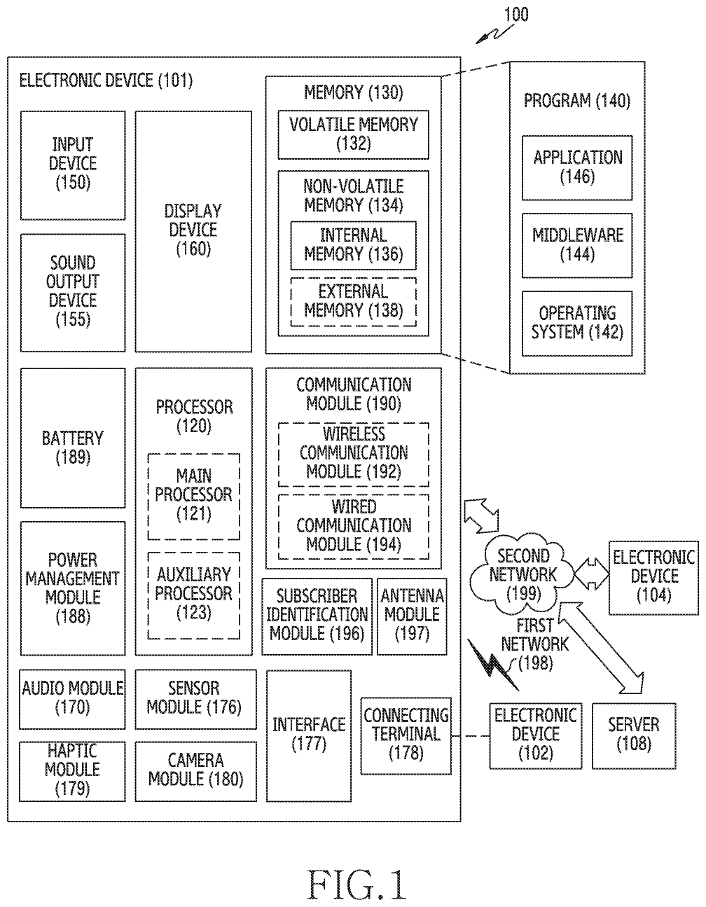

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module(SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture an image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or #08. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor(e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

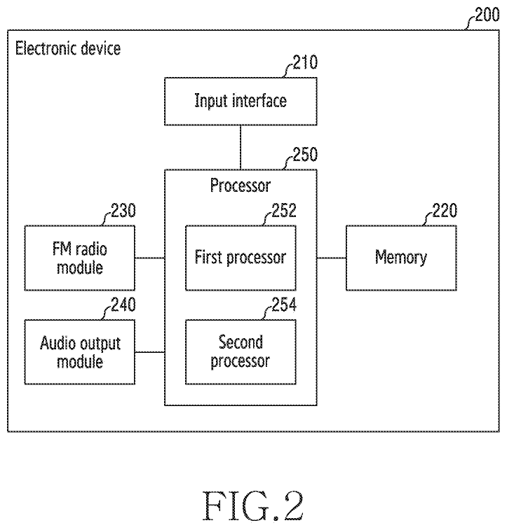

FIG. 2 is a block diagram illustrating an electronic device according to an embodiment of the disclosure.

Referring to FIG. 2, the electronic device 200 may include an input interface 210, a memory 220, an FM radio module 230, an audio output module 240, and a processor 250. In one embodiment, the electronic device 200 may correspond to the electronic device 101 illustrated in FIG. 1.

In one embodiment, the input interface 210 may receive a user input related to an FM radio. In one embodiment, the input interface 210 may receive a user input for at least one of execution, termination, volume control, recording start, recording pause, and recording termination of an FM radio application.

In one embodiment, the input interface 210 may receive various forms of user inputs related to an FM radio. For example, the input interface 210 may receive a touch input to select an icon for executing an FM radio application displayed on a touch screen display (not shown, e.g., the display device 160 of FIG. 1) of the electronic device 200 or for volume control or a soft key. In another example, the input interface 210 may receive a voice command to request the execution of an FM radio application through an activated voice assistant system (e.g., Siri, Bixby, and Google Assistant). In another example, the input interface 210 may receive an input to manipulate (e.g., press or move) a physical key for volume control.

In one embodiment, the memory 220 may store an instruction to control the processor 250, a control instruction code, control information, and software. For example, the memory 220 may include an FM radio application, an operating system, middleware, and a device driver (e.g., an audio driver and an FM radio driver). In one embodiment, the FM radio application, the operating system, the middleware, the device driver, and the like stored in the memory 220 may be configured in a hierarchical structure under the control of the processor 250.

In one embodiment, the memory 220 may store user data. For example, the memory 220 may store user history data, such as an output volume set last when a user terminates the FM radio application.

In one embodiment, the FM radio module 230 may receive FM radio data (or FM radio content) in an audio data format (e.g., a PCM format) from the outside of the electronic device 200. In one embodiment, the FM radio module 230 may be a module including an FM radio chipset. In one embodiment, the FM radio module 230 may include an antenna module (not shown) to receive FM radio data corresponding to a designated frequency band. In one embodiment, the FM radio module 230 may receive information about a volume level from the processor 250, and may receive FM audio data using the information about the volume level or may process (or convert) the received FM audio data using the information about the volume level.

In one embodiment, the FM radio module 230 may provide at least part of the received FM audio data or the processed FM audio data to the processor 250.

In one embodiment, the audio output module 240 may output audio data. In one embodiment, the audio output module 240 may correspond to the sound output device 155 of FIG. 1. In one embodiment, the audio output module 240 may receive audio data to be output from the processor 250 and may output the received audio data.

In one embodiment, the audio output module 240 may include a digital-to-analogue module (DAC) module to output analog audio data. For example, the audio output module 240 may receive digital audio data from the processor 250, may convert the received digital audio data into analog audio data, and may output the analog audio data. In one embodiment, the DAC module may be included in a volume processor 414 rather than in the audio output module 240.

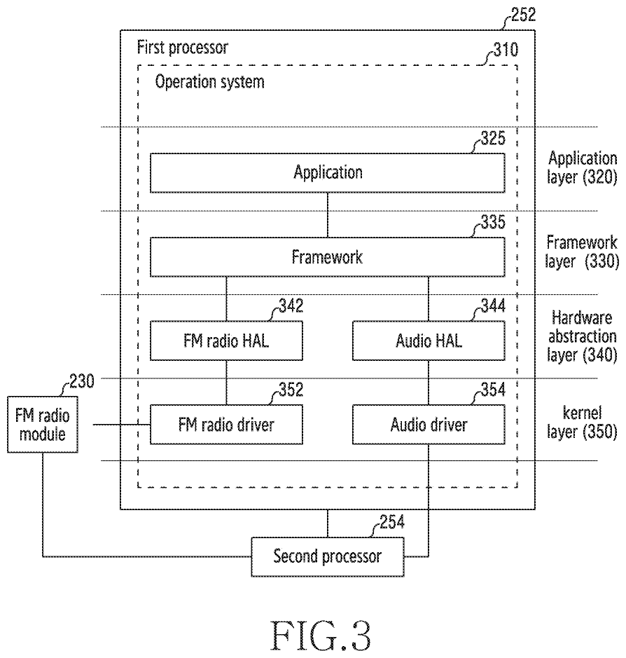

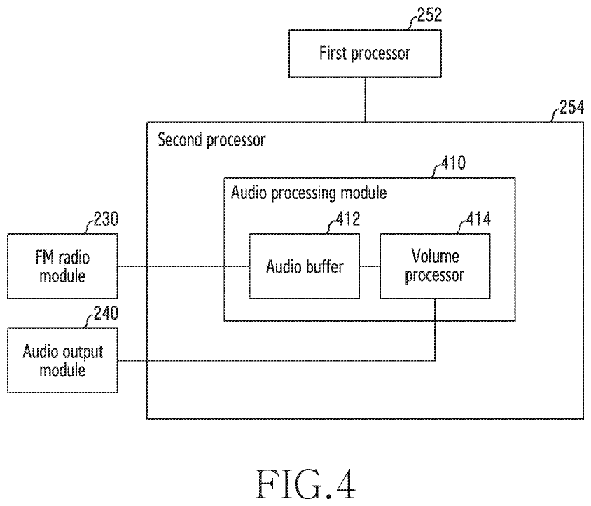

In one embodiment, the processor 250 may control the overall operation of the electronic device 200. In one embodiment, the processor 250 may be an application processor and may execute an instruction stored in the memory 220 or may run an instruction code or software. In one embodiment, the processor 250 may include a first processor 252 or a second processor 254, and the first processor 252 and the second processor 254 may be distinguished depending on activation/deactivation conditions or performed functions (e.g., instructions to execute, software to run, and the like). For example, the first processor 252 may run a hierarchical data structure (or hierarchical software structure, e.g., an operating system) necessary to provide FM audio data to a user according to a user input. In another example, the second processor 254 may run software for processing audio data. The first processor 252 and the second processor 254 are specifically disclosed in FIG. 3 and FIG. 4, respectively.

In one embodiment, the processor 250 may be an application processor (AP).

In one embodiment, the processor 250 may be configured as a system on chip (SoC).

In one embodiment, the processor 250 may include a processor (e.g., a CPU core) to control the overall operation of the electronic device 200 and a plurality of intellectual properties (IPs). At least one IP (e.g., an audio subsystem) among the plurality of IPs may correspond to a specific function (e.g., audio data processing). In one embodiment, the first processor 252 may correspond to the processor to control the overall operation of the electronic device 200, and the second processor 254 may correspond to a microprocessor (MPU) included in the at least one IP among the plurality of IPs. (microprocessor).

FIG. 3 illustrates a first processor according to an embodiment of the disclosure.

For easier understanding, components other than newly introduced components in FIG. 3 are indicated by the same reference numerals as previously used.

Referring to FIG. 3, the first processor 252 may run a data structure (e.g., a program module) necessary to provide FM audio data to a user. In one embodiment, the data structure necessary to provide the FM audio data to the user may include a plurality of layers. In one embodiment, the program module may include an operating system 310 including a plurality of layers, such as an application layer 320, a framework layer 330, a hardware abstraction layer 340, and a kernel layer 350. In one embodiment, at least part of the program module may be preloaded on an electronic device or may be downloaded from an external electronic device.

In one embodiment, the application layer 320 may correspond to at least one application 325 (e.g., an application program) run on the operating system according to a user input. For example, the application 325 may correspond to an FM radio application.

In one embodiment, the framework layer 330 may correspond to a framework 335 providing an API for running the application 325. The framework 335 is, for example, a set of API programming functions, may include a plurality of managers, and may be provided in different configurations depending on an operating system. The framework 335 may provide a data transfer path and a function providing path between the application layer 320 and the hardware abstraction layer 340 so that the application 325 may use a limited system resource inside the electronic device or may control a designated hardware module.

In one embodiment, the hardware abstraction layer (HAL) 340 may provide a standard interface enabling the framework 335 to use various hardware functions or a library module of designated hardware. In one embodiment, the hardware abstraction layer 340 may include an FM radio HAL 342 and an audio HAL 344. In one embodiment, the FM radio HAL 342 may configure an interface for a hardware component of the same type as an FM radio module 230, and may provide the configured interface for the framework 335. In one embodiment, the audio HAL 344 may configure an interface for a hardware component of the same type as an audio output module 240 and may provide the configured interface for the framework 335.

In one embodiment, the kernel layer 350 may include a device driver, which is an instruction set necessary to control various types of hardware, and a system resource manager to control, allocate, or withdraw a system resource. In one embodiment, the device driver may include an FM radio driver 352, which is an instruction set necessary to control the FM radio module 230, and an audio driver 354, which is an instruction set necessary to control the audio output module 240.

In one embodiment, the FM radio driver 352 may be connected to the FM radio module 230 to exchange data. For example, the FM radio driver 352 may transmit, to the FM radio module 230, data indicating (or designating) volume information about FM audio data to be transmitted to a processor 250 or a second processor 254.

In one embodiment, the audio driver 354 may be connected to the second processor 254 to exchange data. For example, the audio driver 354 may transmit, to the second processor 254, data indicating (or designating) volume information about FM audio data to be output to the audio output module 240.

FIG. 4 illustrates a second processor according to an embodiment of the disclosure.

Referring to FIG. 4, for easier understanding, components other than newly introduced components in FIG. 4 are indicated by the same reference numerals as previously used.

In one embodiment, the second processor may include an audio processing module 410. In one embodiment, the audio processing module 410 may receive FM audio data corresponding to a specific volume level and may convert the received FM audio data according to data (e.g., a command or a request) received from a first processor 252. The audio processing module 410 may be referred to as an audio subsystem.

In one embodiment, the audio processing module 410 may include an audio buffer 412 and a volume processor 414.

In one embodiment, the audio buffer 412 may at least temporarily store FM audio data corresponding to a specific volume level received from the FM radio module 230.

In one embodiment, the volume processor 414 may process FM audio data at least temporarily stored in the audio buffer 412. In one embodiment, the volume processor 414 may process FM audio data at least temporarily stored in the audio buffer 412 according to data (e.g., a command or a request) received from the first processor 252.

For example, the volume processor 414 may generate FM audio data corresponding to user volume level information using the user volume level information received from the first processor 252. The volume processor 414 may generate the FM audio data corresponding to the user volume level information using FM audio data corresponding to a specific volume level which is at least temporarily stored in the audio buffer 412. In one embodiment, an operation of generating the FM audio data corresponding to the user volume level information may be performed regardless (or independently) of whether an FM radio recording request is received. That is, even though the FM radio recording request is received or not received, the volume processor 414 may perform the consistent operation.

In another example, the volume processor 414 may transmit FM audio data corresponding to a specific volume level, which is at least temporarily stored in the audio buffer 412, to the first processor 252 (or a recording buffer (not shown) of the first processor 252). In one embodiment, when an FM radio recording request is received from the first processor 252, the volume processor 414 may transmit the FM audio data corresponding to the specific volume level, which is at least temporarily stored in the audio buffer 412, to the first processor 252; when the FM radio recording request is not received, the volume processor 414 may not transmit the FM audio data to the first processor 252.

In one embodiment, the audio processing module 410 may preprocess or postprocess audio data. The audio processing module 410 may preprocess or postprocess audio data (e.g., PCM data) generated by an electronic device 200 or received from an external device. The audio processing module 410 may preprocess or postprocess input audio data (e.g., a transmission signal) input from a microphone (e.g., the input interface 210) of the electronic device 200 or output audio data (e.g., a reception signal) to be output through an audio output module 240. For example, the audio processing module 410 may perform at least one of noise cancelation, filtering, data processing for enhancing sound quality, and data processing for minimizing power consumption when outputting audio data on audio data.

In one embodiment, the audio processing module 410 may include an input/output interface to be operatively connected with the microphone (e.g., the input interface 210) and/or the audio output module 240 of the electronic device 200.

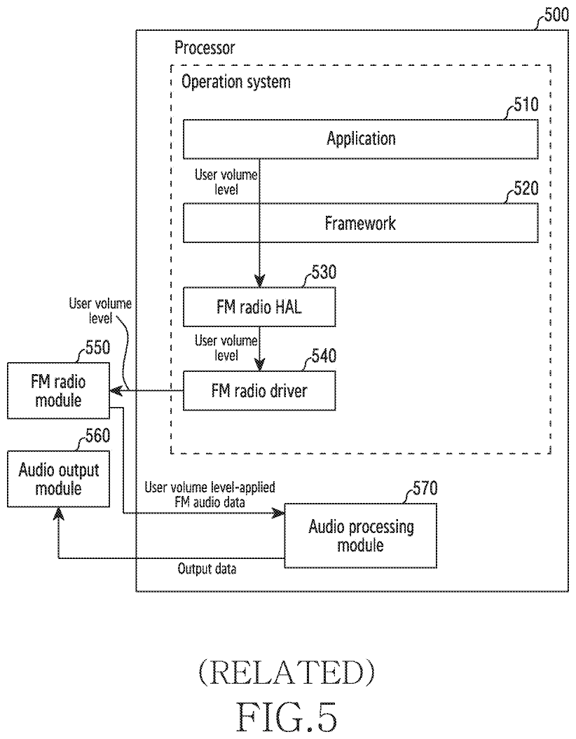

FIG. 5 illustrates data flow for processing user volume control when an FM radio application is operated according to an embodiment of the disclosure.

FIG. 5 illustrates data flow for processing user volume control when a request to record an FM radio is not received.

Referring to FIG. 5, a processor 500 may include an operating system configured in a hierarchical structure and an audio processing module 570. The operating system may include an application 510, a framework 520, an FM radio HAL 530, and an FM radio driver 540. The application 510 may be an FM radio application. The application 510 may transmit information about a user volume level to the FM radio HAL 530 through the framework 520. The user volume level may refer to a volume level set as an output volume of the FM radio. The FM radio HAL 530 may transmit the information about the user volume level to the FM radio driver 540. The FM radio driver 540 may transmit the information about the user volume level to an FM radio module 550. The FM radio module 550 may be a module including an FM radio chipset. The FM radio module 550 may provide FM audio data corresponding to the user volume level (or FM audio data to which the user volume level is applied) to an audio processing module 570, and the audio processing module 570 may provide audio output data corresponding to the user volume level to an audio output module 560.

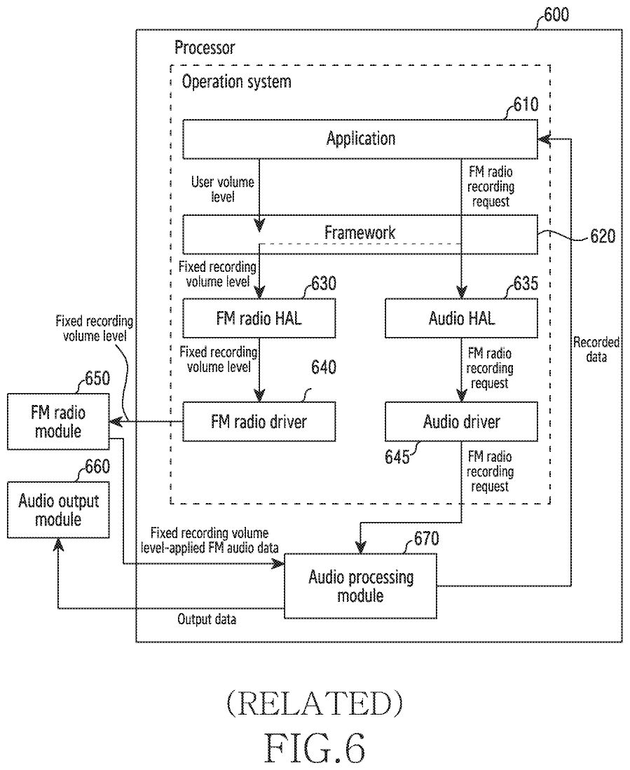

Referring to FIG. 5, the FM radio module 550 is an entity that receives information about a specific volume level and transmits FM audio data corresponding to the specific volume level. That is, the volume control of an FM radio is performed on the basis of hardware. Here, when the FM radio is recorded according to a user input, the volume value of recorded data (or a recording) may not be constant, which is described below with reference to FIG. 6.

FIG. 6 illustrates data flow for processing user volume control when an FM radio application is operated according to an embodiment of the disclosure.

FIG. 6 illustrates data flow 600 for processing user volume control when an FM radio is recorded (or while an FM radio is being recorded) according to a user input (or request).

Referring to FIG. 6, an application 610 may transmit an FM radio recording request to an audio HAL 635 through a framework 620. The application 610 may attempt to transmit information about a user volume level to an FM radio HAL 630 through the framework 620. When the FM radio recording request is not received, the framework 620 may transmit the information about the user volume level to the FM radio HAL 630. However, when the FM radio recording request is received, the framework 620 may transmit information about a fixed recording volume level, instead of the information about the user volume level, to the FM radio HAL 630. The fixed recording volume level may be a volume level irrelevant to volume control of a user. The FM radio HAL 630 may transmit the fixed recording volume level to an FM radio module 650 through an FM radio driver 640. The FM radio module 650 may provide FM audio data corresponding to the fixed recording volume level (or FM audio data to which the fixed recording volume level is applied) to an audio processing module 670. The audio processing module 670 may provide audio output data corresponding to the fixed recording volume level both to an audio output module 660 and to the application 610 or a recording buffer (not shown).

Referring to FIG. 6, a user input for volume control may be restricted or performing a function corresponding to a user input for volume control may be restricted while recording an FM radio according to a user input. That is, in order to control the volume of the FM radio, the user needs to terminate recording of the FM radio or to wait until recording of the FM radio terminates.

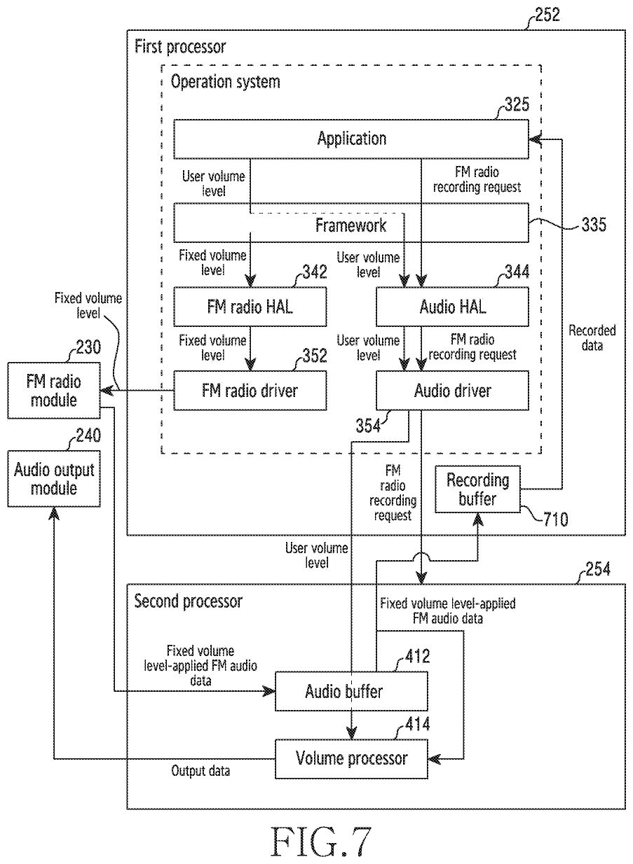

FIG. 7 illustrates data flow for processing user volume control when an FM radio application is operated according to an embodiment of the disclosure.

For easier understanding, components other than newly introduced components in FIG. 7 are indicated by the same reference numerals as previously used.

Referring to FIG. 7, a first processor 252, a second processor 254, an FM radio module 230, and an audio output module 240 are disclosed.

In one embodiment, the first processor 252 may include an application 325, a framework 335, an FM radio HAL 342, an audio HAL 344, an FM radio driver 352, an audio driver 354, and a recording buffer 710.

In one embodiment, the application 325 may transmit data to the framework 335 through different paths. For example, the application 325 may transmit information about a user volume level to a first manager among a plurality of managers included in the framework 335 through a first path 326. In another example, the application 325 may transmit an FM radio recording request to a second manager among the plurality of managers included in the framework 335 through a second path 327.

In one embodiment, the application 325 may transmit the information about the user volume level to the framework 335. The user volume level may refer to a volume level set as an output volume of an FM radio. For example, the user volume level may be a volume level set by a user through a user interface associated with the application 325 (e.g., an execution screen of the application 325) or a user interface of an operating system. In another example, the user volume level may be the last output volume set when the user terminates an FM radio application.

In one embodiment, the application 325 may transmit the FM radio recording request to the audio HAL 344 via the framework 335. For example, when receiving the user's recording request through the user interface associated with the application 325, the application 325 may transmit the FM radio recording request to the framework 335. In one embodiment, the FM radio recording request may include at least one piece of information of a recording start time and an FM radio frequency.

In one embodiment, the framework 335 may transmit information about a fixed volume level to the FM radio HAL 342. In one embodiment, the framework 335 may transmit the information about the fixed volume level to the FM radio HAL 342 regardless of whether the FM radio recording request is received. That is, information about a fixed volume level for recording is transmitted to the FM radio HAL 342 upon receiving an FM radio recording request. In the embodiment, however, the framework 335 may transmit the information about the fixed volume level to the FM radio HAL 342 regardless (or independently) of the reception of the FM radio recording request. In one embodiment, the fixed volume level is volume information to be reflected in a recording of the FM radio and may be a constant volume level over time.

In one embodiment, the framework 335 may transmit the information about the fixed volume level and/or the information about the user volume level to the FM radio HAL 342. The information about the user volume level transmitted to the FM radio HAL 342 may be transmitted from the FM radio HAL 342 to the audio HAL 344 via a path in a hardware abstraction layer 340.

In one embodiment, the framework 335 may transmit the information about the user volume level to the audio HAL 344.

In one embodiment, when the framework 335 transmits the information about the user volume level to the FM radio HAL 342, the information about the user volume level transmitted to the FM radio HAL 342 may be transmitted to the audio HAL 344. Thus, the framework 335 may not transmit the information about the user volume level directly to the audio HAL 344.

In one embodiment, the FM radio HAL 342 may transmit the received information about the fixed volume level to the FM radio driver 352.

In one embodiment, the audio HAL 344 may transmit the received information about the user volume level and the FM radio recording request to the audio driver 354. In one embodiment, the audio HAL 344 may transmit the received information about the user volume level and the FM radio recording request to the audio driver 354 at the same time or at different times.

In one embodiment, the FM radio driver 352 may transmit the information about the fixed volume level to the FM radio module 230.

In one embodiment, the audio driver 354 may transmit the received information about the user volume level and the FM radio recording request to the second processor 254. Specifically, the audio driver 354 may transmit the received information about the user volume level to a volume processor 414 of the second processor 254 and may transmit the FM radio recording request to an audio buffer 412 of the second processor 254.

In one embodiment, the FM radio module 230 may transmit FM audio data corresponding to the fixed volume level (or to which the fixed volume level is applied) to the audio buffer 412 of the second processor 254. In one embodiment, the FM radio module 230 may transmit the FM audio data corresponding to the fixed volume level to the audio buffer 412 regardless of whether the FM radio recording request is received.

In one embodiment, the audio buffer 412 may transmit the FM audio data corresponding to the fixed volume level, received from the FM radio module 230, to at least one external module. For example, the audio buffer 412 may transmit the FM audio data corresponding to the fixed volume level to the volume processor 414 regardless of whether the FM radio recording request is received. In another example, when the FM radio recording request is received, the audio buffer 412 may transmit the FM audio data corresponding to the fixed volume level to a recording buffer 710 of the first processor 252.

In one embodiment, the volume processor 414 may process FM audio data corresponding to a specific volume level. Specifically, the volume processor 414 may convert the FM audio data corresponding to the specific volume level to generate FM audio data corresponding to a different volume level.

In one embodiment, the volume processor 414 may generate FM audio data corresponding to the user volume level using the information about the user volume level received from the audio driver 354 and the FM audio data corresponding to the fixed volume level received from the audio buffer 412.

In one embodiment, the volume processor 414 may transmit the FM audio data corresponding to the user volume level to the audio output module 240.

In one embodiment, the audio output module 240 may output audio data received from the volume processor 414.

In one embodiment, the audio output module 240 may process audio data received from the volume processor 414 and may output the processed audio data. For example, the audio output module 240 may convert digital audio data received from the volume processor 414 into analog audio data and may output the analog audio data.

Referring to FIG. 7, the FM radio module 230 according to an embodiment may provide FM audio data corresponding to a volume level that is always constant regardless of whether an FM radio is recorded (i.e., a fixed volume level) to the audio buffer 412 rather than providing FM audio data corresponding to different volume levels depending on whether an FM radio is recorded. That is, an entity that provides FM audio data corresponding to different volume levels depending on whether an FM radio is recorded may be the second processor 254 rather than the FM radio module 230. Accordingly, the user can control the volume as desired while recording an FM radio. In one embodiment, FM audio data corresponding to different volume levels may be provided on the basis of software through the volume processor 414 included in the second processor 254 or provided on the basis of hardware through a hardware block (not shown) included (e.g., as a SoC) in the second processor 254.

In order to apply a volume processing method provided by a specific operating system (e.g., Android) to FM audio data, there may be an inconvenience of transmitting the FM audio data to the operating system. According to the embodiments illustrated in FIG. 7, such inconvenience may be solved. Specifically, the volume processing method provided by Android employs a method of applying a stream volume value in 15 levels (having a difference of about 3 dB therebetween) according to the user's volume control to a sound source to which a master volume is applied. According to this method, it is necessary to transmit FM audio data to the operating system even when recording is not in progress, and thus all modules including a module for volume processing (e.g., the audio processing module 570 of FIG. 5) need to be activated even during listening and latency is increased. In the embodiments, however, a module for volume processing (e.g., the second processor 254 of FIG. 7) is configured separately from the first processor 252 on which an operating system runs, thereby preventing an increase in latency and an increase in power consumption (e.g., by deactivating the first processor 252 during not recording).

An electronic device according to various embodiments may include: an FM radio module configured to receive FM audio data; an audio output module configured to output audio data; and a processor configured to be operatively connected to the FM radio module, the audio output module, and an audio buffer configured to at least temporarily store the received FM audio data, and configured to include a volume processor configured to adjust a volume level of the received FM audio data, wherein the processor may be configured to: receive FM audio data corresponding to a fixed volume level from the FM radio module to store the FM audio data in the audio buffer; convert the FM audio data corresponding to the fixed volume level, transmitted from the audio buffer, into FM audio data corresponding to a user volume level; and transmit the FM audio data corresponding to the user volume level to the audio output module.

According to various embodiments, the user volume level may be a volume level set as an output volume of an FM radio.

According to various embodiments, the user volume level may be one of a volume level set as a last output volume of an FM radio application when a user terminates the FM radio application or an output volume of the FM radio application set by the user through a user interface.

According to various embodiments, the processor may be configured to receive information about the user volume level from an audio driver of the electronic device.

According to various embodiments, the processor may be further configured to identify whether an FM radio recording request is received from the audio driver.

According to various embodiments, the processor may be configured to convert the FM audio data corresponding to the fixed volume level, transmitted from the audio buffer, into the FM audio data corresponding to the user volume level independently of whether the FM radio recording request is received.

According to various embodiments, the processor may be further configured to transmit the FM audio data corresponding to the fixed volume level, transmitted from the audio buffer, to an external module configured to generate FM radio recording data at least partly on the basis of a determination that the FM radio recording request is received.

An electronic device according to various embodiments may include: an FM radio module configured to receive FM audio data; an audio output module configured to output audio data; and a processor configured to be operatively connected to the FM radio module and the audio output module, wherein the processor may be configured to include a first processor and a second processor, the first processor may be configured to run an FM radio application and to transmit information about a fixed volume level to the FM radio module, and the second processor may be configured to receive FM audio data corresponding to the fixed volume level from the FM radio module, to convert the FM audio data corresponding to the fixed volume level into FM audio data corresponding to a user volume level, and to transmit the FM audio data corresponding to the user volume level to the audio output module.

According to various embodiments, when an FM radio recording request is received, the first processor may be configured to at least temporarily store the FM audio data corresponding to the fixed volume level and to generate an FM radio recording file using the temporarily stored FM audio data.

According to various embodiments, the first processor may be configured to transmit information about the user volume level from the run FM radio application to the second processor through an audio-related path.

According to various embodiments, the audio-related path may include an audio HAL and an audio driver.

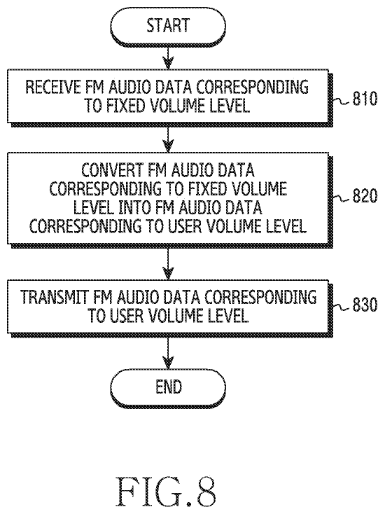

FIG. 8 is a flowchart illustrating an operation sequence of an electronic device according to an embodiment of the disclosure.

Referring to FIG. 8 at least one operation disclosed in FIG. 8 may be performed by a processor (e.g., the processor 250) or a second processor (e.g., the second processor 254). Hereinafter, at least one operation disclosed in FIG. 8 is described as being performed by the second processor 254.

In one embodiment, in operation 810, the second processor 254 may receive FM audio data corresponding to a fixed volume level. For example, the second processor 254 may receive the FM audio data corresponding to the fixed volume level from an FM radio module (e.g., the FM radio module 230).

In one embodiment, the second processor 254 may receive the FM audio data corresponding to the fixed volume level continuously within a designated time period or periodically.

In one embodiment, in operation 820, the second processor 254 may convert the FM audio data corresponding to the fixed volume level into FM audio data corresponding to a user volume level. Specifically, a volume processor 414 of the second processor 254 may receive FM audio data to which the fixed volume level is applied from an audio buffer 412, may receive information about the user volume level from an audio driver (e.g., the audio driver 354), and may convert the FM audio data corresponding to the fixed volume level into the FM audio data corresponding to the user volume level.

In one embodiment, in operation 830, the second processor 254 may transmit the FM audio data corresponding to the user volume level in operation 830. For example, the second processor 254 may transmit the FM audio data corresponding to the user volume level to an audio output module (e.g., the audio output module 240).

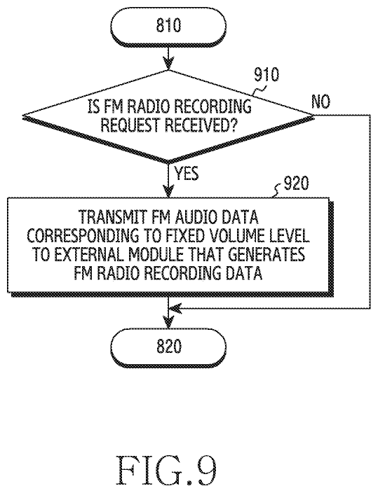

FIG. 9 is a flowchart illustrating an operation sequence of an electronic device according to whether an FM radio recording request is received according to an embodiment of the disclosure.

At least one operation disclosed in FIG. 9 may be an operation performed after operation 810 of FIG. 8 is performed.

In one embodiment, in operation 910, a second processor 254 may determine whether an FM radio recording request is received. For example, the second processor 254 may determine whether the FM radio recording request is received on the basis of a signal or data transmitted from a first processor 252 or an audio driver 354 of the first processor 252.

In one embodiment, when the FM radio recording request is received (Yes in operation 910), the second processor 254 may transmit FM audio data corresponding to a fixed volume level to an external module that generates FM radio recording data in operation 920. In one embodiment, the external module that generates the FM radio recording data may correspond to either the first processor 252 or a recording buffer 710 that stores data used to generate FM radio recording data (e.g., the FM audio data corresponding to the fixed volume) in order to generate the FM radio recording data.

In one embodiment, the second processor 254 may receive information about a user volume level simultaneously with or separately from the FM radio recording request. For example, the second processor 254 may receive, from an audio driver 354, the FM radio recording request and the information about the user volume level together or separately from each other (e.g., may receive information about the user volume level and may then receive the FM radio recording request).

In one embodiment, when the FM radio recording request is not received (No in operation 910), the second processor 254 may perform operation 820. That is, the second processor 254 may convert the FM audio data corresponding to the fixed volume level into FM audio data corresponding to the user volume level in operation 820 regardless (or independently) of whether the FM radio recording request is received. The reason why the operation of converting the FM audio data is performed regardless (or independently) of whether the FM radio recording request is received is because, as described above, an FM radio module always transmits the FM audio data corresponding to the fixed volume level to the second processor 254 regardless of whether an FM radio recording request is received. Here, when the FM radio recording request is received, the second processor 254 further transmits the FM audio data corresponding to the fixed volume level to the external module that generates the recording data.

In one embodiment, the FM radio recording request is described as being received after the FM audio data corresponding to the fixed volume level is received but may be received while the FM audio data corresponding to the fixed volume level is being received.

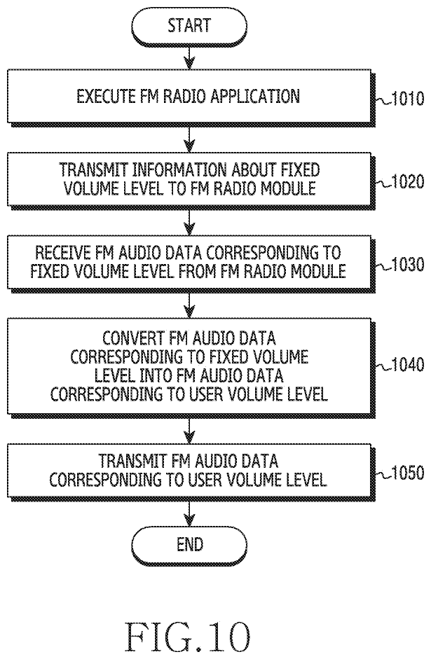

FIG. 10 is a flowchart illustrating an operation sequence of an electronic device according to an embodiment of the disclosure.

Referring to FIG. 10 at least one operation disclosed in FIG. 10 may be performed by a processor 250.

Operations 1010 and 1020 disclosed in FIG. 10 may be performed by a first processor 252, and operations 1030 to 1050 may be performed by a second processor 254.

In one embodiment, the processor 250 may execute an FM radio application in operation 1010. For example, the processor 250 may identify a user input to execute the FM radio application on the basis of a signal received from an input interface (e.g., the input interface 210) and may run (or execute) the FM radio application.

In one embodiment, the processor 250 may transmit information about a fixed volume level to an FM radio module 230 in operation 1020. For example, the processor 250 may transmit the information about the fixed volume level to the FM radio module 230 in an order of a framework (e.g., the framework 335), an FM radio HAL (e.g., the FM radio HAL 342), an FM radio driver (e.g., the FM radio driver 352), and the FM radio module 230. In one embodiment, the fixed volume level may be a volume level irrelevant to a user's volume control, and the information about the fixed volume level may be previously stored in a memory (e.g., the memory 220).

In one embodiment, the processor 250 may receive FM audio data corresponding to the fixed volume level from the FM radio module 230 in operation 1030. For example, the processor 250 may periodically store the FM audio data corresponding to the fixed volume level transmitted from the FM radio module 230 in an audio buffer 412.

In one embodiment, the processor 250 may convert the FM audio data corresponding to the fixed volume level into FM audio data corresponding to a user volume level in operation 1040. For example, the processor 250 may convert the FM audio data corresponding to the fixed volume level, periodically stored in the audio buffer 412, into the FM audio data corresponding to the user volume level using information about the user volume level. In one embodiment, the processor 250 may convert the FM audio data corresponding to the fixed volume level into the FM audio data corresponding to the user volume level regardless of whether an FM radio recording request is received.

In one embodiment, the processor 250 may transmit the FM audio data corresponding to the user volume level in operation 1050. For example, the processor 250 may transmit the FM audio data corresponding to the user volume level to an audio output module 240.

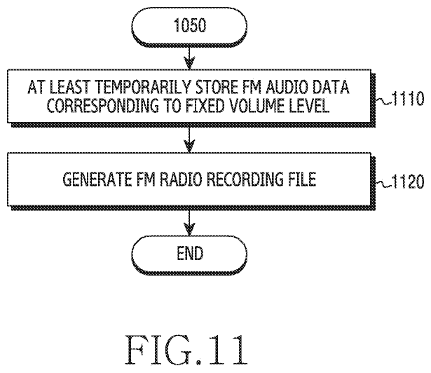

FIG. 11 is a flowchart illustrating an operation sequence of an electronic device for generating an FM radio recording file according to an embodiment of the disclosure.

Referring to FIG. 11 at least one operation disclosed in FIG. 11 may be performed after operation 1050 of FIG. 10 is performed.

At least one operation disclosed in FIG. 11 may be performed by a processor 250 or a first processor 252. Hereinafter, at least one operation disclosed in FIG. 11 is described as being performed by the processor 250.

In one embodiment, in operation 1110, the processor 250 may at least temporarily store FM audio data corresponding to a fixed volume level. For example, the first processor 252 may receive the FM audio data corresponding to the fixed volume level from an audio buffer 412 of a second processor 254 and may at least temporarily store the FM audio data in a recording buffer 710.

In one embodiment, in operation 1120, the processor 250 may generate an FM radio recording file. For example, the processor 250 may generate the FM radio recording file using the FM audio data corresponding to the fixed volume level at least temporarily stored in the recording buffer 710.

An operating method of an electronic device including an FM radio module configured to receive FM audio data and an audio output module configured to output audio data according to various embodiments may include: running an FM radio application; receiving FM audio data corresponding to a fixed volume level through the FM radio module; converting the FM audio data corresponding to the fixed volume level into FM audio data corresponding to a user volume level; and outputting the FM audio data corresponding to the user volume level through the audio output module.

According to various embodiments, the user volume level may be a volume level set as an output volume of an FM radio.

According to various embodiments, the user volume level may be one of a volume level set as a last output volume of an FM radio application when a user terminates the FM radio application or an output volume of the FM radio application set by the user through a user interface.

According to various embodiments, the method may further include identifying information about the user volume level.

According to various embodiments, the method may further include identifying whether an FM radio recording request is received.

According to various embodiments, the converting of the FM audio data corresponding to the fixed volume level into the FM audio data corresponding to the user volume level may be performed independently of whether the FM radio recording request is received.

According to various embodiments, the method may further include at least temporarily storing the FM audio data corresponding to the fixed volume level and generating an FM radio recording file using the temporarily stored FM audio data when the FM radio recording request is received.

While the disclosure has been shown described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
an FM radio module configured to receive FM audio data;
an audio output module configured to output audio data; and
a processor operatively connected to the FM radio module, the audio output module, and an audio buffer configured to at least temporarily store the received FM audio data, including a volume processor configured to adjust a volume level of the received FM audio data,
wherein the processor is configured to:
receive FM audio data corresponding to a fixed volume level from the FM radio module to store the FM audio data in the audio buffer,
convert the FM audio data corresponding to the fixed volume level, transmitted from the audio buffer, into FM audio data corresponding to a user volume level, and
transmit the FM audio data corresponding to the user volume level to the audio output module.

2. The electronic device of claim 1, wherein the user volume level is a volume level set as an output volume of an FM radio.

3. The electronic device of claim 2, wherein the user volume level is one of a volume level set as a last output volume of an FM radio application when a user terminates the FM radio application or an output volume of the FM radio application set by the user through a user interface.

4. The electronic device of claim 2, wherein the processor is further configured to receive information about the user volume level from an audio driver of the electronic device.

5. The electronic device of claim 4, wherein the processor is further configured to identify whether an FM radio recording request is received from the audio driver.

6. The electronic device of claim 5, wherein the processor is further configured to convert the FM audio data corresponding to the fixed volume level, transmitted from the audio buffer, into the FM audio data corresponding to the user volume level independently of whether the FM radio recording request is received.

7. The electronic device of claim 5, wherein the processor is further configured to transmit the FM audio data corresponding to the fixed volume level, transmitted from the audio buffer, to an external module configured to generate FM radio recording data at least partly based on a determination that the FM radio recording request is received.

8. An electronic device comprising:
an FM radio module configured to receive FM audio data;
an audio output module configured to output audio data; and
a processor operatively connected to the FM radio module and the audio output module,
wherein the processor comprises:
a first processor, and
a second processor,
wherein the first processor is configured to:
execute an FM radio application, and
transmit information about a fixed volume level to the FM radio module, and
wherein the second processor is configured to:
receive FM audio data corresponding to the fixed volume level from the FM radio module,
convert the FM audio data corresponding to the fixed volume level into FM audio data corresponding to a user volume level, and
transmit the FM audio data corresponding to the user volume level to the audio output module.

9. The electronic device of claim 8, wherein, when an FM radio recording request is received, the first processor is further configured to at least temporarily store the FM audio data corresponding to the fixed volume level and to generate an FM radio recording file using the temporarily stored FM audio data.

10. The electronic device of claim 8, wherein the first processor is further configured to transmit information about the user volume level from the FM radio application to the second processor through an audio-related path.

11. The electronic device of claim 10, wherein the audio-related path comprises an audio hardware abstraction layer (HAL) and an audio driver.

12. An operating method of an electronic device comprising an FM radio module configured to receive FM audio data and an audio output module configured to output audio data, the method comprising:
executing an FM radio application;
receiving FM audio data corresponding to a fixed volume level through the FM radio module;
converting the FM audio data corresponding to the fixed volume level into FM audio data corresponding to a user volume level; and
outputting the FM audio data corresponding to the user volume level through the audio output module.

13. The method of claim 12, wherein the user volume level is a volume level set as an output volume of an FM radio.

14. The method of claim 12, wherein the user volume level is one of a volume level set as a last output volume of an FM radio application when a user terminates the FM radio application or an output volume of the FM radio application set by the user through a user interface.

15. The method of claim 12, further comprising identifying information about the user volume level.

16. The method of claim 15, further comprising identifying whether an FM radio recording request is received.

17. The method of claim 16, wherein the converting of the FM audio data corresponding to the fixed volume level into the FM audio data corresponding to the user volume level is performed independently of whether the FM radio recording request is received.

18. The method of claim 16, further comprising at least temporarily storing the FM audio data corresponding to the fixed volume level and generating an FM radio recording file using the temporarily stored FM audio data when the FM radio recording request is received.
